(19) United States
(12) Patent Application Publication
(10) Pub. No.: US 2007/0051222 A1
(43) Pub. Date: Mar. 8, 2007

(54) One-piece cutting die structure with integrated packing

(76) Inventor: Chia Shun Lee, Taoyuan County (TW)

Correspondence Address: NIKOLAI & MERSEREAU, P.A., 900 SECOND AVENUE SOUTH, SUITE 820, MINNEAPOLIS, MN, 55402, US

(21) Appl. No.: 11/218,686

(22) Filed: Sep. 6, 2005

(51) Int. Cl. B26D 1/00

(52) U.S. Cl. 83/651

(57) ABSTRACT

A one-piece cutting die structure includes integrated packing. The blades of said cutting die integrates with a polyurethane form. The reverse side of said cutting die integrates with a flat packing layer upon which the pattern, title, product number, source of goods, and/or barcode of the cutting die can be printed on the surface thereof for identification marking. In addition, the area of the polyurethane form is larger than that of the cutting die, thereby enabling the packing layer to bind with the polyurethane form and placing the cutting die in-between. Therefore, the cutting die and the packing are integrated in one piece, so that the cutting die can be directly used without extra packing material to be removed and while reducing the waste of discarding the packing material, economizing the packing cost, and enabling the identification marking of the cutting die to be printed out. Thus, those users who possess a large number of various cutting dies are able to easily find and manage their cutting dies for use.

### BACKGROUND OF THE INVENTION

1) Field of the Invention

This invention relates to a one-piece cutting die structure with integrated packing, in particular, to a structure that a cutting die and its packing are integrally formed, thereby enabling the cutting die to have the identification marking function. The invention is suitable for use of plastic steel cutting die, wooden cutting die, embossed pattern or the same in arts and crafts.

2) Description of the Prior Art

With the prevalence of arts and crafts creation, more and more patterns or characters are applied to cards, photo albums, quilts, posters, display windows or stage design, so that said patterns or characters are made by trimming materials, such as paper, plastics, photographic paper, etc., on various cutting dies with said pattern or character forms.

To satisfy the user needs for obtaining various creative patterns, craft creators or consumers are able to purchase all sorts of well packed cutting dies on the market and die-cut different patterns with said cutting dies, which are packed with descriptions, product sources and/or barcodes marked on paper plate or paper with a plastic sack or case wrapped externally for consumers to purchase. After any cutting die with aforementioned wrapping is purchased, the paper and packing case with labeling is then discarded, so as to generate the waste of wrapping material without conforming to the environmental protection concept. In addition, the cost of such conventional packing method is high. The pattern on protuberant small blades of an uncovered cutting die are unable to be easily recognized, in addition, relevant cutting die information, such as product name, product no., source of goods, and/or product trademark, are unable to be found or seen.

In addition, uncovered blades of a cutting die without packing are easily worn down, polluted, oxidized, or harm a user; therefore, for the purpose of user safety, blades of a cutting die are mostly covered with a thin form for the purposes of preventing the blades from damage, protecting the user from harm, and assisting the user in quickly die-cutting the material from the cutting die. Even though said uncovered blades of a cutting die comprise the aforementioned drawbacks, the pattern of a cutting die is still visible; nevertheless, the pattern of a cutting die is not easily recognized after its blades are covered with a polyurethane form. Hence, another conventional cutting die design shows a f-shape plastic cover with labeling of the no. and trademark set on the reverse side of the cutting die. Nevertheless, said plastic cover is not a flat surface and easily generates cracks after being pressurized, thereby enabling said cutting die to have uneven pressing points.

In view of the foregoing drawbacks, the present invention described herein provides a more practicable cutting die structure, so as to conform to the concepts of environmental protection, reduce the packing cost and provide the improvement of conventional cutting die.

### SUMMARY OF THE INVENTION

The main objective of the invention is to provide a one-piece cutting die structure with integrated packing, so as to economize the use of packing material, reduce the packing cost and conform to the concept of environmental protection.

Another objective of the invention is to provide a one-piece cutting die structure with integrated packing, enabling the cutting die to possess the identification marking function for the purposes of the user safety and being easily managed by users.

Another objective of the invention is to provide a one-piece cutting die structure in integrated packing, which enables said cuffing die to have even pressing points, so as to quickly cut the whole beautiful pattern slices from the cutting die.

To achieve the above objectives, said cutting die structure of the invention is to enable blades of the cutting die to be integrated with a polyurethane form for the effect of safety use. Said cutting die has a flat packing layer on the reverse side thereof to enable characters and labeling to be printed out on the surface thereof. Seeing that the areas of said polyurethane form and said packing layer are both larger than the cutting die, the packing layer of said cutting die is able to bind with said polyurethane form, placing said cutting die in-between; thereby said one-piece integrated packing has the functions of protecting said cutting die and identification marking. In addition, as the packing layer is a flat structure, the cutting die is able to be pressed evenly without affecting the pattern cutting quality.

Further aspects, objects, desirable features, and advantages of the invention will be better understood from the detailed description and drawings that follow in which various embodiments of the disclosed invention are illustrated by way of example.

### BRIEF DESCRIPTION OF THE DRAWINGS

FIG. 1 is a perspective view of a first embodiment of this invention;

FIG. 2 is another perspective view of the first embodiment of this invention;

FIG. 3 is another perspective view of the first embodiment of the invention;

FIG. 4 is a perspective view of a second embodiment of the invention; and

FIG. 5 is a perspective view of a third embodiment of the invention.

### DETAILED DESCRIPTION OF THE PREFERRED EMBODIMENTS

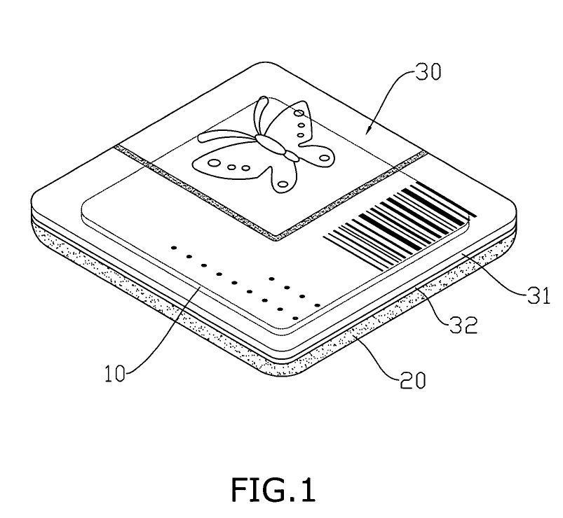

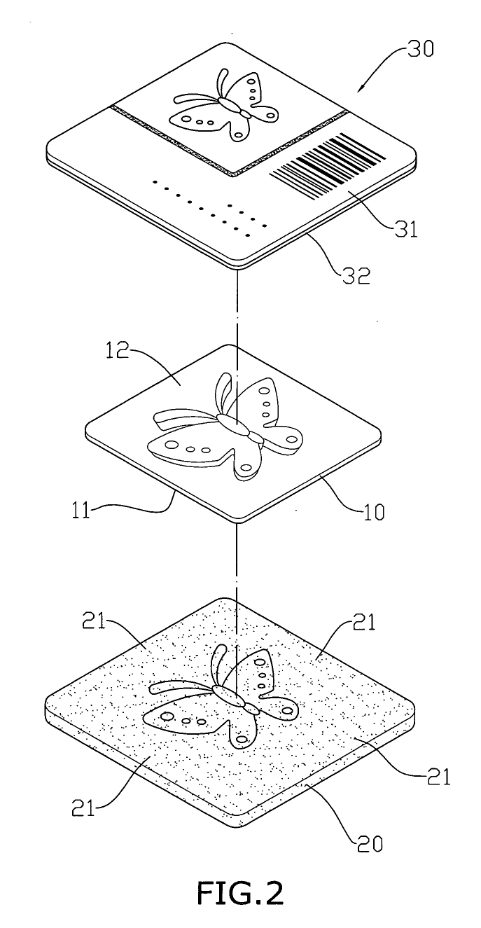

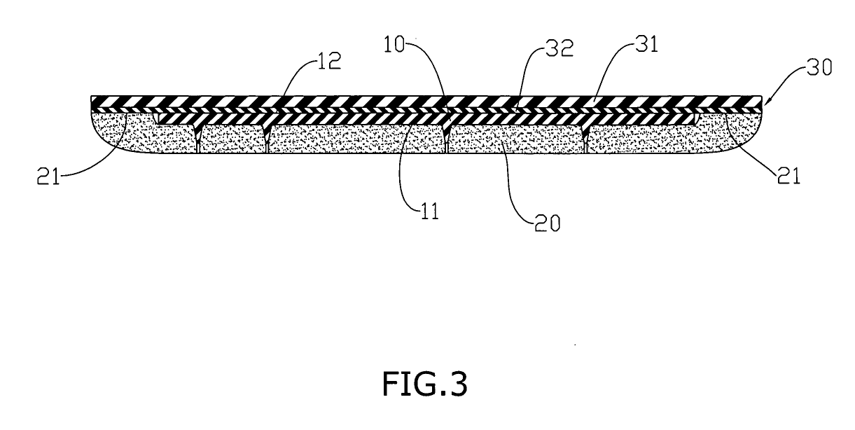

With reference to a first embodiment shown in FIGS. 1, 2 and 3, the invention comprises: a cutting die 10; protuberant blades 11 of the cutting die 10 are integrated with a polyurethane form 20, so that the blades are protected; the polyurethane form 20 has the same pattern and lines on the edges connecting with the blades and is larger than the cutting die 10 in area; a faying surface 21 extends out of the edge of the polyurethane form 20 formed on the peripheral of the cutting die 10; the reverse side 12 of the cutting die 10 has a flat packing layer 30, which is a thin slice formed by binding a transparent plastic film 31 and a paper 32 with pattern and characters printed on the surface thereof; the area of the thin slice is larger than that of the cutting die 10, the same as the polyurethane form 20, so as to form a faying surface on the peripherals of the cutting die 10 and bind with the faying surface 21 of said polyurethane form 20 placing the cutting die 10 in-between.

Seeing that the packing layer is a flat structure and the polyurethane form has the soft and elastic characteristics, the polyurethane form can slightly bend to closely bind with the packing layer, thereby enabling entire structure to form a flat and light packing with the cutting die in one piece. Therefore, said cutting die can be directly used without additional external packing to be removed and no unnecessary packing waste is generated; in addition, the packing cost can be substantially reduced without the use of excessive packing material. Therefore, the invention packing conforms to the concept of environmental protection.

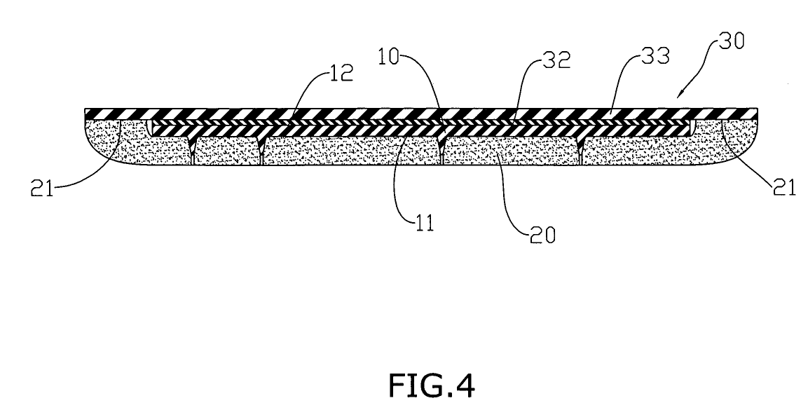

With reference to a second embodiment of the invention shown in FIG. 4, the blades 11 of the cutting die 10 integrate with the polyurethane form 20 to protect the cutting die; the area of the polyurethane form 20 is larger than that of the cutting die 10, extending out and forming the faying surface 21 on the peripherals of the cutting die 10. The reverse side of the cutting die 10 integrates the flat packing layer 30, which is formed by a transparent film 33 and the paper 32 with pattern and characters printed on the surface thereof, said paper 32 has the same area size as that of the cutting die 10 and plasters on the reverse side of the cutting die 10; said transparent film 33 covers over the surface of the paper 32 and has the same area size as that of the polyurethane form 20, the peripheral of said transparent film 33 binds with the faying surface 21 on the peripheral of the polyurethane form 20, packing the cutting die 10 in-between and forming a creative, light and flat packing, thereby enabling the cutting die to possess the identification marking function.

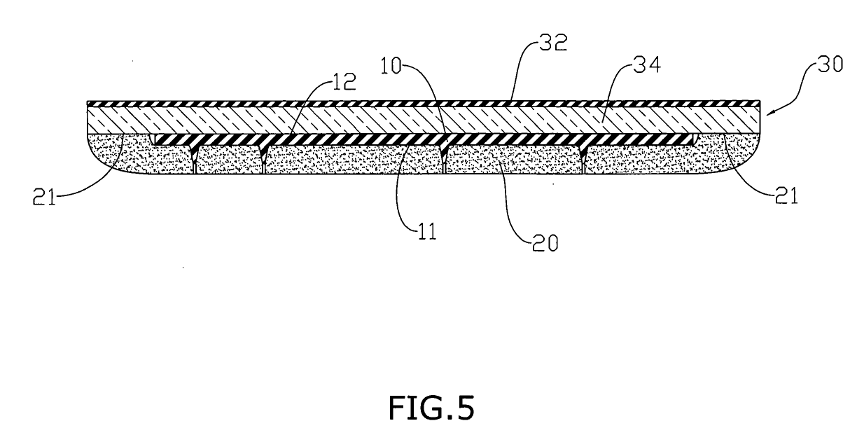

With the reference to a third embodiment of the invention shown in FIG. 5, the blades 11 of the cutting die 10 integrate with the polyurethane form 20, the area of the polyurethane form 20 is larger than that of the cutting die 10, extending out and forming the faying surface 21 on the peripherals of the cutting die 10. The reverse side of the cutting die 10 integrates a flat packing layer 30, which is formed by a fiber board 34 and the paper 32 with pattern and characters printed on the surface thereof, the surface of the paper 32 is covered with a transparent light film to protect the printing on the paper; the inner surface of the fiber board 34 is bond with the reverse side of the cutting die 10 on the faying surface 21 of the peripheral of the polyurethane form 20, so as to achieve the purpose of integrating the packing with the cutting die in one-piece.

In view of the foregoing, the invention integrates the packing with the cutting die in one-piece for achieving the objectives of user safety, enabling a creative and light packing, reducing the waste of discarding the packing material, economizing the packing cost, enabling the packing layer to have the pattern, title, no., barcode, source of goods of the cutting die printed out and providing clear identification marking function, so that those users who possess a large number of various cutting dies are able to easily find and manage their cutting dies for use. The flat packing layer enables even pressing points on the cutting die during cutting for a user to quickly cut out beautiful and delicate pattern slices.

New characteristics and advantages of the invention covered by this document have been set forth in the foregoing description. It is of course to be understood, however, that this disclosure is, in many respects, only illustrative. Changes may be made in details without exceeding the scope of the invention by those who are skilled in the art under the doctrine of equivalents. The scope of the invention is, of course, defined in the language in which the appended claims are expressed.

1. A one-piece cutting die structure with integrated packing, comprising: a cutting die including a base having a peripheral edge, with the base having a forward aide and a reverse side each having an area, with the base having a constant thickness between the forward and reverse sides, with the cutting die further including blades protruding from the forward side of the base; a polyurethane form having an area slightly larger than the base of the cutting die with the polyurethane form including a cavity of a depth generally equal to the constant thickness of the base and of a size and shape for receipt of the base of the cutting die, with the polyurethane form having patterns and lines extending from the cavity for receiving the blades of the cutting die, with the polyurethane form extending over and covering the blades when the base of the cutting die is received in the cavity and the polyurethane form is not compressed; and a packing layer having an area that is equivalent to the area of said polyurethane form, with the packing layer abutting with the reverse side of the cutting die received in the cavity of the polyurethane form and binding with the polyurethane form outside of and around the peripheral edge of the base of the cutting die, wherein the packing layer possesses printing characters for the purpose of identification marking.

2. (canceled)

3. The cutting die structure of claim 1, wherein the packing layer is a thin slice formed by a transparent plastic film of a constant thickness bond to a paper of a constant thickness, with the paper including pattern and characters printed on the surface thereof, wherein the area of the packing layer formed by the thin slice is larger than that of the cutting die, the packing layer formed by the paper is larger than that of the cutting die.

4. The cutting die structure of claim 1, wherein the packing layer is a transparent film of a constant thickness and a paper of a constant thickness, with the paper including pattern and characters printed on the surface thereof, wherein the paper has a same area size as that of the cutting die and located on the reverse side of the cutting die, wherein the transparent film covers over the paper having the same shape and size as the polyurethane form, wherein said transparent film binds with the of the polyurethane form outside of the paper and the cutting die.

5. The cutting die structure of claim 1, wherein the packing layer is formed by a fiber board and a the paper with pattern and characters printed on the surface thereof; and wherein an inner surface of the fiber board is located on the reverse side of the cutting die of the peripheral of the polyurethane form.

6. The cutting die structure of claim 5, wherein a surface of the paper opposite to the fiber board is covered with a transparent light film.

7. The cutting die structure of claim 1, wherein the packing layer enables the combination of either a pattern, a character, or a barcode to be printed thereon.
